(19) United States
(12) Patent Application Publication
(10) Pub. No.: US 2025/0232314 A1
(43) Pub. Date: Jul. 17, 2025

(54) SYSTEMS AND METHODS FOR USING ARTIFICIAL INTELLEGENCE FOR COMPLIANCE REGULATION

(71) Applicant: Fidelity Information Services, LLC, Jacksonville, FL (US)

(72) Inventors: Milind K. PANDYA, Bangalore (IN); Nisheet MISHRA, Lucknow (IN); Koneru Venkata Surya PRAKASH, Chennai (IN); Shridhar KANAKARAJ, Bengaluru (IN); Mayur Shankar JADHAV, Ambernath (IN)

(21) Appl. No.: 18/735,602

(22) Filed: Jun. 6, 2024

(30) Foreign Application Priority Data
Jan. 12, 2024 (IN) 202411002404

(51) Int. Cl. G06Q 30/018; G06F 9/451

(52) U.S. Cl. CPC G06Q 30/018; G06F 9/451

(57) ABSTRACT

A method for using artificial intelligence for compliance regulation includes capturing one or more document files from one or more websites according to a list of trusted websites. The method may further include extracting a plurality of document data from the one or more document files. The method may further include providing the plurality of document data to a comparison machine-learning model. The comparison machine-learning model may be trained to identify changes within the plurality of document data and a plurality of previous document data and generate a report based on the identified changes. The method may further include transmitting the report to a user interface.

### CROSS-REFERENCE TO RELATED APPLICATION(S)

This application claims the benefit or priority to Indian Application No. 202411002404, filed on Jan. 12, 2024, the entirety of which is incorporated herein by reference.

### TECHNICAL FIELD

Various embodiments of this disclosure relate generally to artificial intelligence and machine-learning-based techniques for managing system compliance.

### BACKGROUND

Corporations, financial institutions, and other organizations face significant challenges in ensuring their compliance with current government and legal regulations. When such regulations change, organizations need the ability to quickly compile and adapt to the changes. Currently, individuals such as product owners or business analysts manually visit publication websites to check for new changes. The changes are consolidated and features and built for existing systems to accommodate the changes. This manual process, however, is resource intensive. Further, human error can lead to significant risk of non-compliance for organizations and businesses. Compliance risk mitigation may come at a large cost to organizations to cover legal and/or regulatory sanctions, financial loss, damage to reputation, and the like.

Unless otherwise indicated herein, the materials described in this section are not prior art to the claims in this application and are not admitted to be prior art, or suggestions of the prior art, by inclusion in this section.

### SUMMARY OF THE DISCLOSURE

In one aspect, an exemplary embodiment of a method for using artificial intelligence for compliance regulation includes capturing one or more document files from one or more websites according to a list of trusted websites. The method may further include extracting a plurality of document data from the one or more document files. The method may further include providing the plurality of document data to a comparison machine-learning model. The comparison machine-learning model may be trained to identify changes within the plurality of document data and a plurality of previous document data and generate a report based on the identified changes. The method may further include transmitting the report to a user interface.

In another aspect, an exemplary embodiment of a system for using artificial intelligence for compliance regulation may include a memory storing instructions and a comparison machine-learning model. The comparison machine-learning model may be trained to identify changes within a plurality of document data and a plurality of previous document data and generate a report based on the identified changes. The system may further include a processor operatively connected to the memory and configured to execute the instructions to perform operations. The operations may include capturing one or more document files from one or more websites according to a list of trusted websites. The operations may further include extracting the plurality of document data from the one or more document files. The operations may further include providing the plurality of document data to the comparison machine-learning model. The operations may further include transmitting the report to a user interface.

In another aspect, an exemplary embodiment of a non-transitory computer-readable medium may include storing instructions that, when executed by one or more processors, perform operations. The operations may include capturing one or more document files from one or more websites according to a list of trusted websites. The operations may further include extracting a plurality of document data from the one or more document files. The operations may further include providing the plurality of document data to a comparison machine-learning model. The comparison machine-learning model may be trained to identify changes within the plurality of document data and a plurality of previous document data and generate a report based on the identified changes. The operations may further include transmitting the report to a user interface.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 depicts an exemplary environment for using artificial intelligence for compliance regulation, according to one or more embodiments.

FIG. 2 depicts a data flow diagram of a system for using artificial intelligence for compliance regulation, according to one or more embodiments.

FIG. 3 depicts a flowchart of an exemplary method for using artificial intelligence for compliance regulation, according to one or more embodiments.

FIG. 4 depicts a flow diagram for training a machine-learning model, according to one or more embodiments.

FIG. 5 depicts an example of a computing device, according to one or more embodiments.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION

Various aspects of the present disclosure relate generally to artificial intelligence and machine-learning-based techniques for managing system compliance and, more particularly, to systems and methods for compliance regulation. Using generative artificial intelligence models, changes to regulatory documents may be identified. An artificial intelligence agent, using large language models (LLMs) may identify regulation changes and their respective functional importance. Further, a user story (e.g., JIRA story) may be generated in human readable text that conveys not only the regulatory changes, but also the functional importance of each of the identified changes.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine-learning and artificial intelligence, it should be understood that techniques according to this disclosure may be adapted to any suitable type of machine-learning and artificial intelligence. It should also be understood that the examples above are illustrative only. The techniques and technologies of this disclosure may be adapted to any suitable activity.

While regulatory and compliance applications and various aspects relating to compliance (e.g., corporate compliance) are described in the present aspects as illustrative examples, the present aspects are not limited to such examples. For example, the present aspects can be implemented for other types of fields, such as in any scenario related to identifying data, comparisons of data and/or text, or generating reports, and the like.

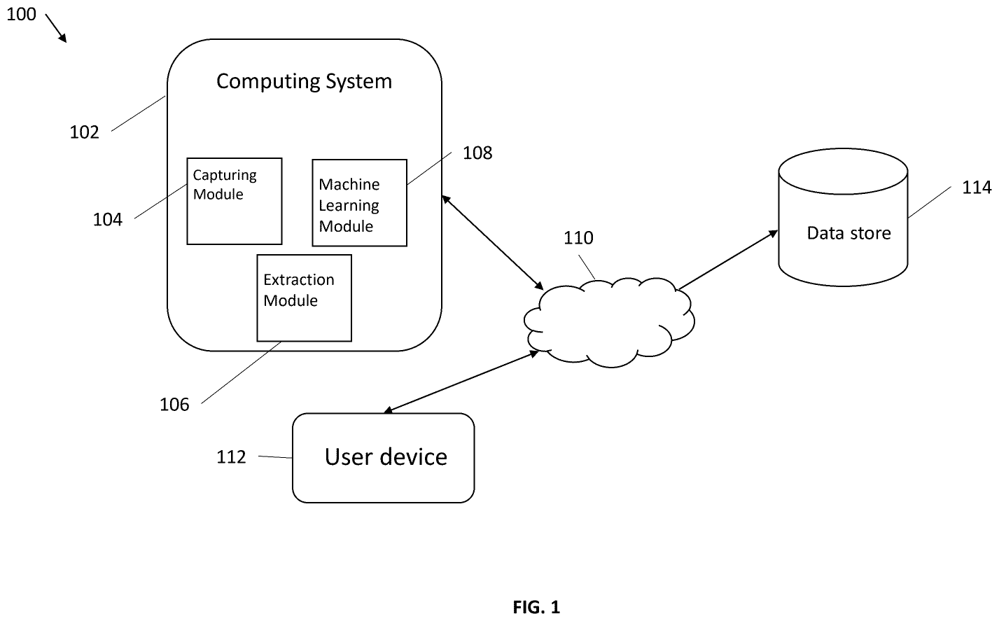

FIG. 1 depicts an exemplary environment 100 that may be utilized with techniques presented herein. One or more user device(s) 112 may communicate across an electronic network 110. The one or more user device(s) 112 may be associated with a user, e.g., a compliance officer, an administrator of one or more components of environment 100, or the like. As will be discussed in further detail below, one or more computing system(s) 102 may communicate with one or more of the other components of the environment 100 across electronic network 110.

The user device(s) 112 may be configured to enable a user to access and/or interact with other systems in the environment 100. For example, the user device(s) 112 may each be a computer system such as, for example, a desktop computer, a mobile device, a tablet, etc. In some embodiments, the user device(s) 112 may include one or more electronic application(s), e.g., a program, plugin, browser extension, etc., installed on a memory of the user device(s) 112. In some embodiments, the electronic application(s) may be associated with one or more of the other components in the environment 100. For example, the electronic application(s) may include one or more of system control software, system monitoring software, software development tools, etc.

In various embodiments, the environment 100 may include a data store 114 (e.g., database). The data store 114 may include a server system and/or a data storage system such as computer-readable memory such as a hard drive, flash drive, disk, etc. In some embodiments, the data store 114 includes and/or interacts with an application programming interface for exchanging data to other systems, e.g., one or more of the other components of the environment. The data store 114 may include and/or act as a repository or source for storing document files, lists of trusted websites, document data, previous document data, input and/or output of the machine-learning or artificial intelligence models, generated reports, and the like (e.g., a user of user device 112 or any of the other components of environment 100).

In some embodiments, the components of the environment 100 are associated with a common entity, e.g., a corporate or financial institution, a service provider, an account provider, or the like. For example, in some embodiments, computing system 102 and data store 114 may be associated with a common entity. In some embodiments, one or more of the components of the environment is associated with a different entity than another. For example, computing system 102 may be associated with a first entity (e.g., a service provider) while data store 114 may be associated with a second entity (e.g., a storage entity providing storage services to the first entity). The systems and devices of the environment 100 may communicate in any arrangement. As will be discussed herein, systems and/or devices of the environment 100 may communicate in order to one or more of generate, train, or use a machine-learning and/or artificial intelligence model for compliance regulation, among other activities.

As discussed in further detail below, the computing system(s) 102 may one or more of (i) generate, store, train, or use a machine-learning model configured to identify regulatory changes. The computing system(s) 102 may include a machine-learning model and/or instructions associated with the machine-learning model, e.g., instructions for generating a machine-learning model, training the machine-learning model, using the machine-learning model etc. The computing system(s) 102 may include instructions for retrieving data, adjusting data, e.g., based on the output of the machine-learning model, and/or operating a display of the user device(s) 112 to output the results, e.g., as adjusted based on the machine-learning model. The computing system(s) 102 may include training data, e.g., document data and previous document data, and may include ground truth, e.g., (i) training document data and (ii) training previous document data.

As depicted in FIG. 1, computing system(s) 102 may include capturing module 104. In various embodiments, capturing module 104 is configured to capture one or more document files from one or more websites according to a list of trusted websites. For example, the websites may include government websites that public regulatory information, such as tax information on a website maintained by the Internal Revenue Service (IRS). In examples, the document files may be documents covering regulations published by the entity or entities that maintain the trusted websites (e.g., PDF files, DOCX files, website content, or the like). The document files may be received or downloaded by computing system(s) 102 over network 110. In examples, the document files may be scraped from the websites. In other examples, the document files may be captured by computing system(s) 102 according to a predetermined schedule (e.g., each night, once per week, once per year, upon publishing of the document files, or the like).

Computing system(s) 102 may also include extraction module 106. In various embodiments, extraction module 106 may be configured to extract document data from the document files. In examples, the document data may include textual and/or numerical information included within the document files. The document data may be stored in data store 114 and retrieved by components of computing system 102 for use.

As depicted in FIG. 1, computing system(s) 102 may also include machine-learning module 108. In some embodiments, a system or device other than the computing system(s) 102 is used to generate and/or train the machine-learning model. For example, such a system may include instructions for generating the machine-learning model, the training data and ground truth, and/or instructions for training the machine-learning model. A resulting trained-machine-learning model may then be provided to the computing system(s) 102.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations, identify patterns, and/or identify changes within document data and to generate a report based on the identified changes.

In various embodiments, the variables of a machine-learning model may be interrelated in any suitable arrangement in order to generate the output. For example, in some embodiments, the machine-learning model may include data processing architecture that is configured to identify, isolate, and/or extract features in a plurality of document data and/or document files. For example, the machine-learning model may include one or more convolutional neural network (“CNN”) configured to identify changes in document data, and may include further architecture, e.g., a connected layer, neural network, etc., configured to determine a relationship between the identified changes in order to output a prediction, action to be taken, or to generate a report.

In some embodiments, the machine-learning model of the computing system 102 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive a sequence of document data and output a report, or the like.

As depicted in FIG. 1, environment 100 may also include electronic network 110. In various embodiments, the electronic network 110 may be a wide area network (“WAN”), a local area network (“LAN”), personal area network (“PAN”), or the like. In some embodiments, electronic network 110 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

Although depicted as separate components in FIG. 1, it should be understood that a component or portion of a component in the environment 100 may, in some embodiments, be integrated with or incorporated into one or more other components. In another example, the computing system 102 may be integrated in a data storage system. The data storage system may be configured to communicate and/or receive/send data across electronic network 110 to other components of environment 100. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to process document data are discussed in further detail in the methods below.

In the following methods, various acts may be described as performed or executed by a component from FIG. 1, such as the computing system 102, the user device 112, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

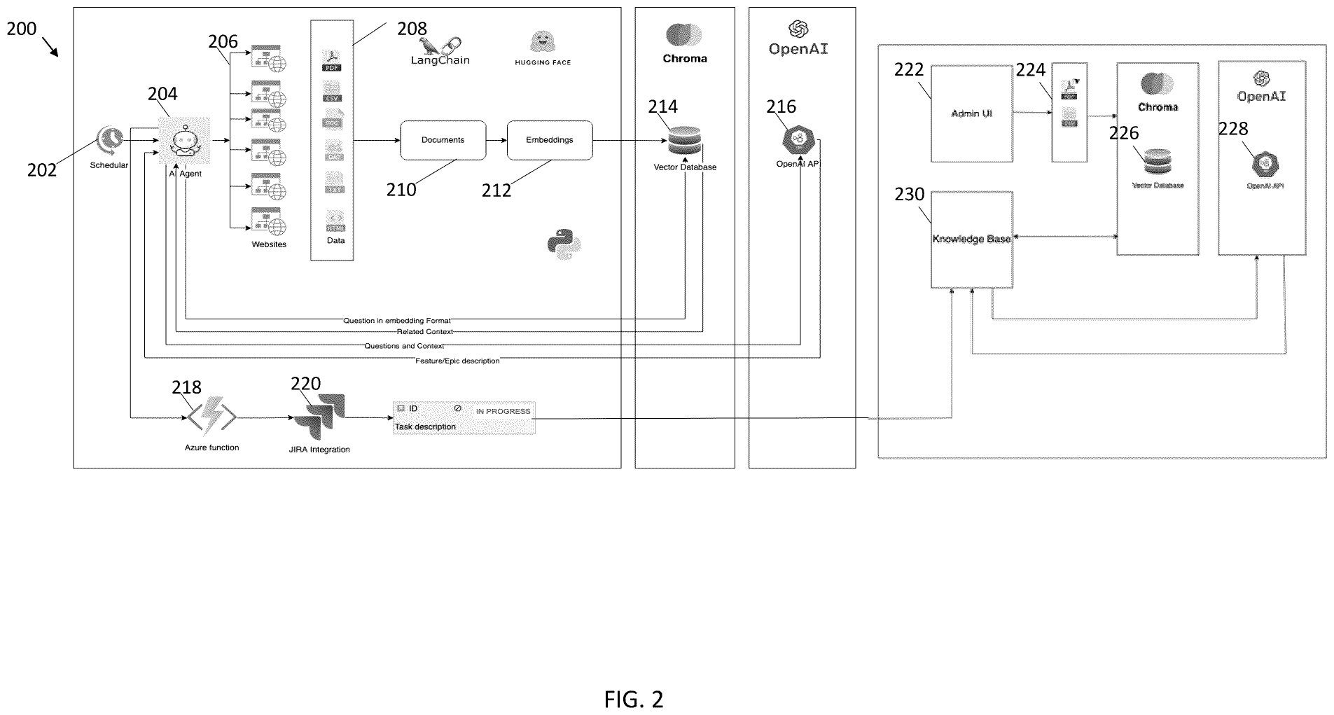

FIG. 2 depicts a data flow diagram of a system for using artificial intelligence for compliance regulation. A scheduler 202 may schedule the capturing (e.g., scraping, downloading, and the like) of document files. As described above, the capturing may be done according to a predetermined schedule, which may be set via scheduler 202 by a user, by the computing system, by an artificial intelligence and/or machine-learning module, or the like. An artificial intelligence (AI) agent 204 may identify regulation changes and their respective functional importance. For example, the functional importance to a change regarding contact information for the Internal Revenue Service may be less than a change to how to file taxes for an employee using a 1099 form.

A list of trusted websites 206 may be scraped and document files 210 may be captured from the trusted websites 206. In examples, such trusted websites may be official websites (e.g., irs.gov, or the like), or websites commonly known to reliably publish accurate regulatory updates. In various implementations, an artificial intelligence model may be used to determine the reliability of a website and add it to the list of trusted websites 206. The document files 210 may be captured (e.g., downloaded from the website) in a variety of document formats 208 (e.g., .PDF, .CSV, .DOC, .DOCX, .TXT, .HTML, or the like).

The document data may be extracted and fragmented into document data 212 (e.g., embeddings). The document data may be stored within a vector database 214. In various embodiments, the document data 212 may then be provided to a machine-learning or artificial intelligence model 216 to identify changes between the document data 212 and previous document data. In examples, the previous document data may have been captured by the computing system in the same way the document data had been captured, though earlier in time. The previous document data may be included within a library stored in a data store, such as data store 114 as depicted in FIG. 1. The previous document data may also be provided to an artificial intelligence model to train the model to determine context and identify the changes. The output, or generated report, may be presented using an Azure function 218 and/or a JIRA integration 220.

Further, in various embodiments, an administrator user interface 222 may be accessed to input document files 224. The document data may be stored within a vector database 226. The document data may then be provided to a machine-learning or artificial intelligence model 228 to identify changes between the document data bad previous document data. The document data and/or output from the machine-learning or artificial intelligence model 228 may be stored within a knowledge base 230.

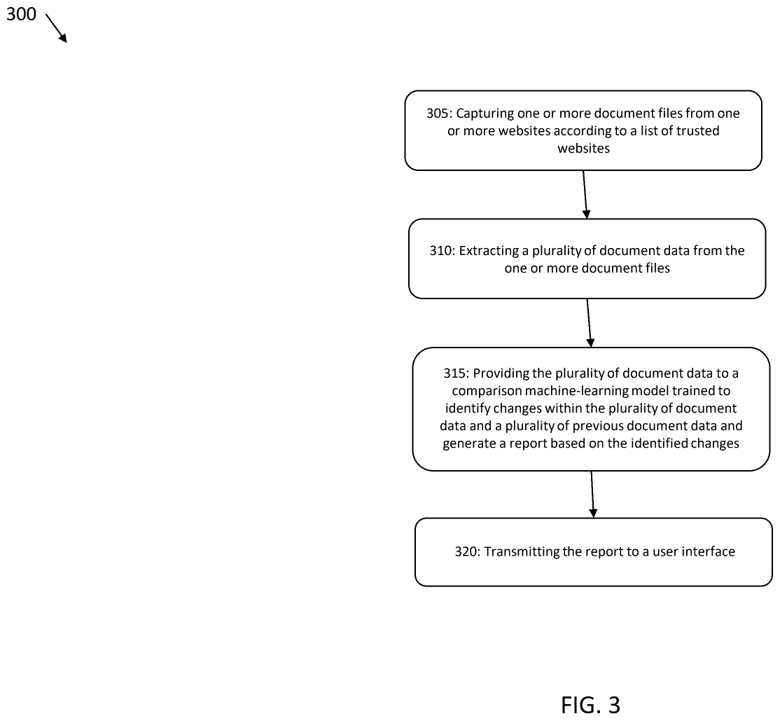

FIG. 3 depicts an exemplary method 300 for using artificial intelligence for compliance regulation. Exemplary method 300 begins with step 305, wherein one or more document files may be captured from one or more websites according to a list of trusted websites. In examples, the capturing may be done by a capturing module of a computing system, such as capturing module 104 as depicted in FIG. 1. The capturing may be done according to a predetermined schedule (e.g., once per night, once per year, when an update to a document file is detected, or the like). The schedule may be set by a user via a user interface or may be automatically determined by the computing system. At step 310, a plurality of document data may be extracted from the one or more document files. In examples, the extracting may be done by an extraction module, such as extraction module 106 as depicted in FIG. 1. The extracted document data may be stored in a data store, such as data store 114 as depicted in FIG. 1.

At step 315, the plurality of document data may be provided to a comparison machine-learning model. The comparison machine-learning model may have been trained to identify changes within the plurality of document data and a plurality of previous document data and to generate a report based on the identified changes. In various embodiments, the machine-learning model may be implemented by an artificial intelligence model, such as the LLM model, or the like, as described above. The document data may be provided to the comparison machine-learning model as fragmented document data. The fragmented document data may be fragmented into one or more chunks of document data, each of a predetermined size. In various embodiments, the size of the fragments may be determined by the comparison machine-learning model or by the computing system based on the determined context of the document files. In examples, the comparison machine-learning module may be implemented by a machine-learning module, such as machine-learning module 108 as depicted in FIG. 1.

At step 320, the report may be transmitted to a user interface. The generated report may be presented in a natural language format. In a particular example, the comparison machine-learning model may account for the context of the reported information by generating text that not only identifies the changes in the document data, but explains the context related to the changes. In examples, the user interface may be included within a user device, such as user device 112 as depicted in FIG. 1. In various embodiments, the report may be provided to a chat artificial intelligence model that may have been trained to process user questions and generate responses to the user questions. In a particular example, if a regulatory change to tax filings associated with 1099 forms is identified by the comparison machine-learning model, then the chat artificial intelligence model may provide a contextually accurate answer to a question posed by a user, such as “What is a 1099 form?” The responses generated by the chat artificial intelligence model may be transmitted to the user interface. In examples, the user may input the user questions into the user interface.

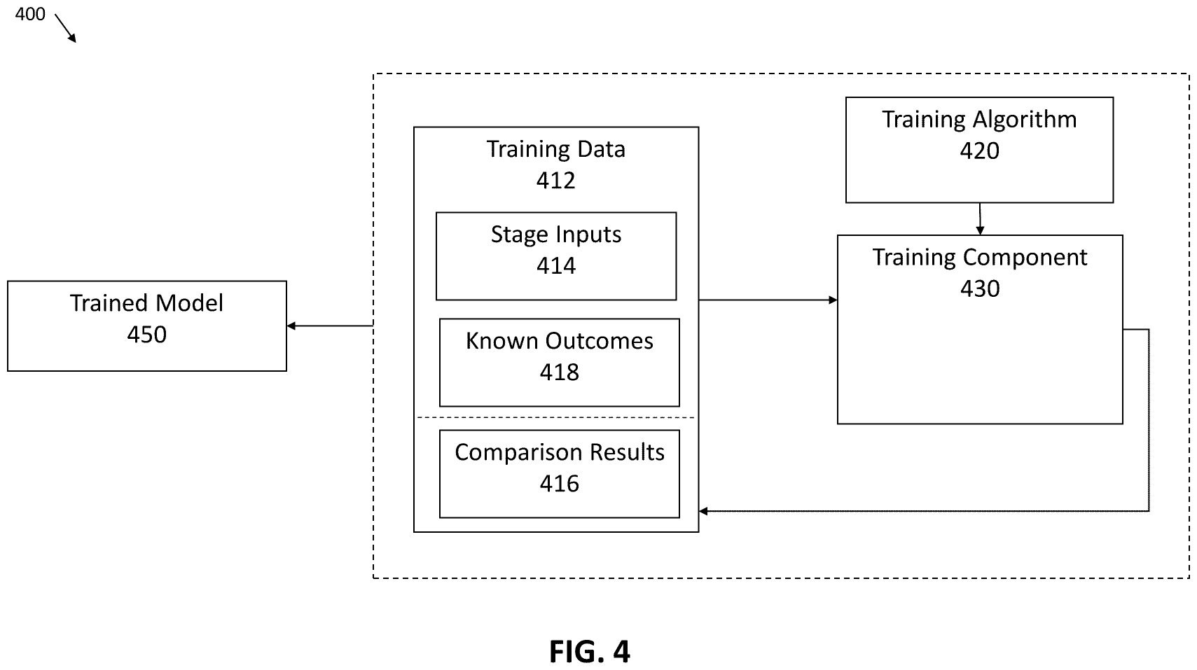

FIG. 4 depicts a flow diagram for training a machine-learning model. As shown in flow diagram 400 of FIG. 4, training data 412 may include one or more of stage inputs 414 and known outcomes 418 related to a machine-learning model to be trained. The stage inputs 414 may be from any applicable source including a component or set shown in the figures provided herein. The known outcomes 418 may be included for machine-learning models generated based on supervised or semi-supervised training. An unsupervised machine-learning model might not be trained using known outcomes 418. Known outcomes 418 may include known or desired outputs for future inputs similar to or in the same category as stage inputs 414 that do not have corresponding known outputs.

The training data 412 and a training algorithm 420 may be provided to a training component 430 that may apply the training data 412 to the training algorithm 420 to generate a trained machine-learning model 450. According to an implementation, the training component 430 may be provided comparison results 416 that compare a previous output of the corresponding machine-learning model to apply the previous result to re-train the machine-learning model. The comparison results 416 may be used by the training component 430 to update the corresponding machine-learning model. The training algorithm 420 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flowchart 400 may be a trained machine-learning model 450.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously update based on feedback associated with use or implementation of the machine-learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

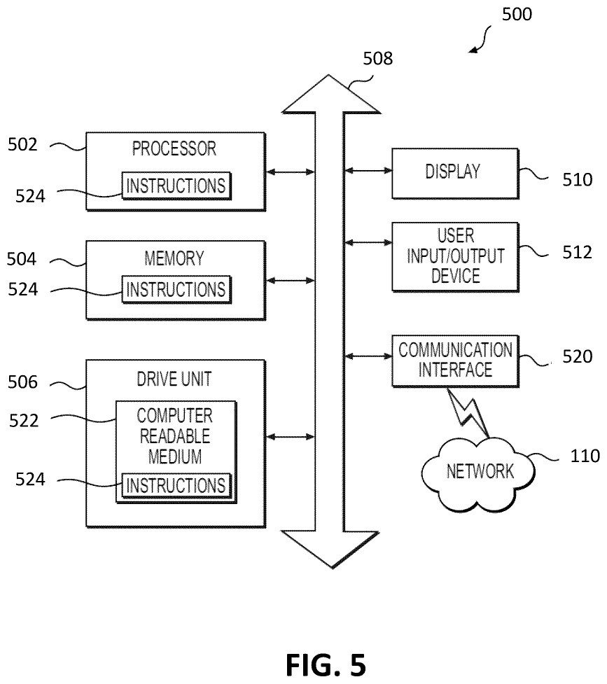

FIG. 5 is a simplified functional block diagram of a computer 500 that may be configured as a device for executing the methods disclosed here, according to exemplary aspects of the present disclosure. For example, the computer 500 may be configured as a system according to exemplary aspects of this disclosure. In various aspects, any of the systems herein may be a computer 500 including, for example, a data communication interface 520 for packet data communication. The computer 500 also may include a central processing unit (“CPU”) 502, in the form of one or more processors, for executing program instructions. The computer 500 may include an internal communication bus 508, and a storage unit 506 (such as ROM, HDD, SDD, etc.) that may store data on a computer readable medium 522, although the computer 500 may receive programming and data via network communications.

The computer 500 may also have a memory 504 (such as RAM) storing instructions 524 for executing techniques presented herein, for example the methods described with respect to FIGS. 2-4, although the instructions 524 may be stored temporarily or permanently within other modules of computer 500 (e.g., processor 502 and/or computer readable medium 522). The computer 500 also may include input and output ports 512 and/or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for using artificial intelligence for compliance regulation, the method comprising:
capturing, by one or more processors, one or more document files from one or more websites according to a list of trusted websites;
extracting, by the one or more processors, a plurality of document data from the one or more document files;
providing, by the one or more processors, the plurality of document data to a comparison machine-learning model trained to identify changes within the plurality of document data and a plurality of previous document data and generate a report based on the identified changes; and
transmitting the report to a user interface by the one or more processors.

2. The computer-implemented method of claim 1, wherein the capturing is according to a predetermined schedule.

3. The computer-implemented method of claim 1, wherein the comparison machine-learning model is an artificial intelligence model.

4. The computer-implemented method of claim 3, wherein the plurality of document data is provided to the comparison machine-learning model as fragmented document data.

5. The computer-implemented method of claim 4, wherein the fragmented document data is fragmented into one or more chunks of document data, each of a predetermined size.

6. The computer-implemented method of claim 1, wherein the report generated by the comparison machine-learning model is in a natural language format.

7. The computer-implemented method of claim 1, further comprising:
providing, by the one or more processors, the report to a chat artificial intelligence model trained to process one or more user questions and generate one or more responses;
transmitting the one or more user questions to the user interface by the one or more processors.

8. A system for using artificial intelligence for compliance regulation, the system comprising:
a memory storing instructions and a comparison machine-learning model trained to identify changes within a plurality of document data and a plurality of previous document data and generate a report based on the identified changes; and
a processor operatively connected to the memory and configured to execute the instructions to perform operations including:
capturing, by the processor, one or more document files from one or more websites according to a list of trusted websites;
extracting, by the processor, the plurality of document data from the one or more document files;
providing, by the processor, the plurality of document data to the comparison machine-learning model; and
transmitting the report to a user interface by the one or more processors.

9. The system of claim 8, wherein the capturing is according to a predetermined schedule.

10. The system of claim 8, wherein the comparison machine-learning model is an artificial intelligence model.

11. The system of claim 10, wherein the plurality of document data is provided to the comparison machine-learning model as fragmented document data.

12. The system of claim 11, wherein the fragmented document data is fragmented into one or more chunks of document data, each of a predetermined size.

13. The system of claim 8, wherein the report generated by the comparison machine-learning model is in a natural language format.

14. The system of claim 8, further comprising:
providing, by the processor, the report to a chat artificial intelligence model trained to process one or more user questions and generate one or more responses;
transmitting the one or more user questions to the user interface by the processor.

15. A non-transitory computer-readable medium storing instructions that, when executed by one or more processors, perform operations including:
capturing, by one or more processors, one or more document files from one or more websites according to a list of trusted websites;
extracting, by the one or more processors, a plurality of document data from the one or more document files;
providing, by the one or more processors, the plurality of document data to a comparison machine-learning model trained to identify changes within the plurality of document data and a plurality of previous document data and generate a report based on the identified changes; and
transmitting the report to a user interface by the one or more processors.

16. The non-transitory computer-readable medium of claim 15, wherein the capturing is according to a predetermined schedule.

17. The non-transitory computer-readable medium of claim 15, wherein the plurality of document data is provided to the comparison machine-learning model as fragmented document data.

18. The non-transitory computer-readable medium of claim 17, wherein the fragmented document data is fragmented into one or more chunks of document data, each of a predetermined size.

19. The non-transitory computer-readable medium of claim 17, wherein the report generated by the comparison machine-learning model is in a natural language format.

20. The non-transitory computer-readable medium of claim 17, further comprising:
providing, by the one or more processors, the report to a chat artificial intelligence model trained to process one or more user questions and generate one or more responses;
transmitting the one or more user questions to the user interface by the one or more processors.
